(19) United States
(12) Patent Application Publication
(10) Pub. No.: US 2025/0243824 A1
(43) Pub. Date: Jul. 31, 2025

(54) INTEGRATED GASIFICATION AND POWER GENERATION SYSTEM AND METHODS OF USE

(71) Applicant: Arbor Energy and Resources Corporation, El Segundo, CA (US)

(72) Inventors: Aaron Ezekiel SMITH, Hermosa Beach, CA (US); Grant Joseph NICCUM, Gardena, CA (US)

(73) Assignee: Arbor Energy and Resources Corporation, El Segundo, CA (US)

(21) Appl. No.: 19/038,339

(22) Filed: Jan. 27, 2025

Related U.S. Application Data
(60) Provisional application No. 63/713,234, filed on Oct. 29, 2024.
(60) Provisional application No. 63/626,257, filed on Jan. 29, 2024.

(51) Int. Cl. F02G 5/02; C10J 3/72

(52) U.S. Cl. CPC F02G 5/02; C10J 3/723; C10J 2200/09; C10J 2300/0916

(57) ABSTRACT

An integrated gasification and power generation system includes a gasifier configured to receive biomass and generate syngas, wherein the gasifier is configured to operate at a pressure of approximately 100 bar to approximately 400 bar. The system further includes a recuperated Brayton thermodynamic power generation loop configured to receive the generated syngas and convert the generated syngas into a CO₂ working fluid, wherein at least a portion of the CO₂ working fluid from the power generation loop is reintroduced from the power generation loop to the gasifier.

### CROSS REFERENCE TO RELATED APPLICATIONS

This application claims priority to U.S. Provisional Application No. 63/713,234, filed on Oct. 29, 2024, and U.S. Provisional Application No. 63/626,257, filed on Jan. 29, 2024, which are hereby incorporated by reference in their entireties.

### TECHNICAL FIELD

Various embodiments of the present disclosure relate generally to gasifiers and, in some aspects, high-pressure gasifiers, integrated into a power generation system, as well as related methods of use. In some aspects, a gasifier according to the current disclosure may be integrated into a combined power generation and carbon capture system. In some aspects, the gasifier may be configured to utilize carbon dioxide (CO₂) as the working fluid.

### BACKGROUND

Currently, fossil fuels are used to generate a majority of the electrical energy needed for the world's ever-growing population. The combustion of fossil fuels results in the emission and release of carbon dioxide (CO₂) and other common greenhouse gases, which has caused the atmospheric composition of the planet to change. Over the centuries, emissions have risen at exponential rates and have given rise to global warming. Accordingly, there is a need for new “green” technologies to be developed to decrease humanity's reliance on fossil fuels. While new innovations in wind, solar, and even nuclear energies show great promise, none of these options appear capable of replacing fossil fuels in the short term. Generating electric power from biomass feedstocks has the potential to meet power demand while simultaneously reducing atmospheric CO₂ levels.

One potential option for generating electrical energy from biomass feedstocks is gasification. Gasification is a process that converts carbonaceous raw materials, like biomass, into a synthetic gas (“syngas”) fuel. Current gasifiers generally utilize air, oxygen, or steam to operate; however, these inputs have drawbacks. Air, for example, introduces a substantial amount of nitrogen into the syngas, which may make it inappropriate for use with carbon capture. Oxygen gasification relies on an energy-intensive supply of gaseous oxygen for the energy to gasify, which can result in low overall efficiencies of the system. Similarly, the power required to generate steam is high, resulting in low overall power cycle efficiency if the steam's latent heat of vaporization cannot be recovered. Accordingly, a need exists for high efficiency integrated gasification and power generation systems and methods of use that are compatible with carbon capture.

The present disclosure is accordingly directed to addressing one or more of the foregoing issues. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, an integrated gasification and power generation system is disclosed.

In one aspect, an integrated gasification and power generation system may include a gasifier configured to receive biomass and generate syngas, wherein the gasifier is configured to operate at a pressure of approximately 100 bar to approximately 400 bar. The system may further include a recuperated Brayton thermodynamic power generation loop configured to receive the generated syngas and convert the generated syngas into a CO₂ working fluid, wherein at least a portion of the CO₂ working fluid from the power generation loop is reintroduced from the power generation loop to the gasifier.

In another aspect, an integrated gasification and power generation system may include a gasifier configured to receive biomass and generate syngas, and to combust the syngas into a CO₂ working fluid, wherein the gasifier is configured to operate at a pressure of approximately 100 bar to approximately 400 bar. The system may further include a recuperated Brayton thermodynamic power generation loop configured to receive the CO₂ working fluid, wherein at least a portion of the CO₂ working fluid is reintroduced from the power generation loop to the gasifier.

In yet another aspect, a method of operating an integrated gasification and power generation system may include receiving biomass within a gasifier, using the biomass and oxygen, generating syngas within the gasifier, wherein the gasifier is operated at a pressure of approximately 100 bar to approximately 400 bar, and combusting the syngas to form and heat a CO₂ working fluid. The method may further include passing the CO₂ working fluid through a turbine, passing the CO₂ working fluid through a recuperator, passing the CO₂ working fluid through a compressor, passing at least a portion of the CO₂ working fluid back through the recuperator, and passing at least a portion of the CO₂ working fluid back into the gasifier.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate the disclosed embodiments, and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure. In the drawings:

FIG. 1 depicts a schematic illustration of an exemplary integrated gasification and power generation system, according to various aspects of the present disclosure.

FIG. 2 depicts a schematic illustration of another exemplary integrated gasification and power generation system, according to various aspects of the present disclosure.

FIG. 3 depicts a schematic illustration of another exemplary integrated gasification and power generation system, according to various aspects of the present disclosure.

FIG. 4 depicts a schematic illustration of another exemplary integrated gasification and power generation system, according to various aspects of the present disclosure.

FIG. 5 depicts a schematic illustration of another exemplary integrated gasification and power generation system, according to various aspects of the present disclosure.

### DETAILED DESCRIPTION OF THE EMBODIMENTS

Both the foregoing general description and the following detailed description are exemplary and explanatory only and are not restrictive of the features, as claimed. In this disclosure, the term “based on” means “based at least in part on.” The singular forms “a,” “an,” and “the” include plural referents unless the context dictates otherwise. As used herein, the terms “comprises,” “comprising,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” An embodiment or implementation described herein as “exemplary” is not to be construed as preferred or advantageous, for example, over other embodiments or implementations; rather, it is intended to reflect or indicate that the embodiment(s) is/are “example” embodiment(s).

It should be noted that all numeric values disclosed or claimed herein (including all disclosed values, limits, and ranges) may have a variation of +/−10% (unless a different variation is specified) from the disclosed numeric value. Moreover, in the claims, values, limits, and/or ranges mean the value, limit, and/or range +/−10%. In addition, relative terms, such as “approximately” and “about” are generally used to indicate a possible variation of ±10% of a stated or understood value unless indicated otherwise in the specification. In addition, the term “between” used in describing ranges of values is intended to include the minimum and maximum values described herein. The use of the term “or” in the claims and specification is used to mean “and/or” unless explicitly indicated to refer to alternatives only, or the alternatives are mutually exclusive, although the disclosure supports a definition that refers to only alternatives and “and/or.” As used herein, “another” may mean at least a second or more.

As used herein, certain terms, e.g., “working fluid,” “CO₂ stream,” “syngas stream,” “stream,” and other like terms may be used interchangeably throughout the description of the embodiments.

Additional objects and advantages of the embodiments will be set forth in part in the description that follows, and in part will be obvious from the description, or may be learned by practice of the embodiments. It is to be understood that both the foregoing general description and the following detailed description are exemplary and explanatory only and are not restrictive of the claims.

Embodiments of the present disclosure are drawn to power generation systems having an integrated gasifier and that may include a carbon capture system, as well as methods of using the same. Accordingly, exemplary embodiments of the integrated gasification and power generation system utilize a biomass fuel source that is converted into carbon dioxide (CO₂), heat, and/or power using recuperated Brayton or Brayton thermodynamic power cycles. In these thermodynamic cycles, carbon dioxide (CO₂), which may or may not be in the form of supercritical carbon dioxide (sCO₂), may be used as the main working fluid. The proposed integrated system may utilize the CO₂ working fluid to divert heat to various portions of the power generation systems to gain efficiencies, and may allow for use of a higher-pressure system. At least some of the heat and power generated from the thermodynamic cycle of the disclosed systems may be used, e.g., to do one or more of drive carbon capture, to sustain or fuel the integrated system (e.g., utilizing heat from the turbine exhaust to generate syngas in the gasifier to feed the combustor to sustain the overall system), to thermally condition various system components (e.g., heating or cooling of the gasifier or the combustor), to quench the syngas flow coming out of the gasifier reactor, or to produce other forms of power (e.g., the power may be converted to electrical power that is utilized for grid integration or the power may be output in the form of mechanical power), as will be described in further detail below.

Traditionally, the operating pressures of sCO₂ cycles are higher than those of commercially available gasifiers, which generally operate at ambient or relatively low pressures. As a result, conventional gasifiers generally require a series of steps to condition and compress the syngas fuel for combustion in a sCO₂ cycle, which may decrease the efficiency of the cycle. For example, the syngas from a traditional gasifier may need to be cooled down to almost ambient temperature, then flowed through one or more compressors to be suitable for introduction to a direct-fired sCO₂ cycle. This cooling and compression may waste heat and energy. By contrast, integrated systems of the present disclosure may be designed to operate at relatively higher pressures, even within the gasifier. Use of a high-pressure gasifier may avoid or mitigate the need for compression power loss and may maintain heat within the power generation cycle.

Another benefit of integrated systems of the present disclosure may be that use of a high-pressure working fluid, such as CO₂, may result in a higher power density, which may allow for machinery to be relatively smaller and more compact compared to traditional power generation machinery. Further, the heat transfer coefficient inside of the gasifier may be relatively high, allowing heating to occur more quickly, and resulting in shorter biomass particle residence times. By contrast, traditional gasifier systems may require larger equipment and may take a longer time to gasify the solid feedstock.

Other benefits of the present disclosure are the use of CO₂ as a gasifying medium. Because traditional gasifiers are designed to operate at relatively lower pressures, e.g., approximately ambient pressures, traditional power generation systems may not work with CO₂ as the gasifying medium, as CO₂ requires higher pressures, which may decrease efficiency for the reasons described above. However, high-pressure systems, such as those described herein, may be suitable for use with CO₂ as the gasifying medium. CO₂ may be a surprisingly good gasifying medium, because when CO₂ contacts the carbon of the biomass feedstock, it is more stable for it to bind to the carbon and form carbon monoxide (CO), according to the following equation known as the Boudouard Reaction: C+CO₂→2CO. CO₂ is an effective gasification moderator due to its activity in helping oxidize more carbon through a Boudouard reaction, which may result in much higher cold gas efficiency and reduced tar generation. Further, high-pressure systems of the present disclosure may be compatible with carbon capture, providing a greener source of energy.

The subject matter of the present disclosure will now be described more fully hereinafter with reference to the accompanying drawings, which form a part hereof, and which show, by way of illustration, specific exemplary embodiments. Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment, and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

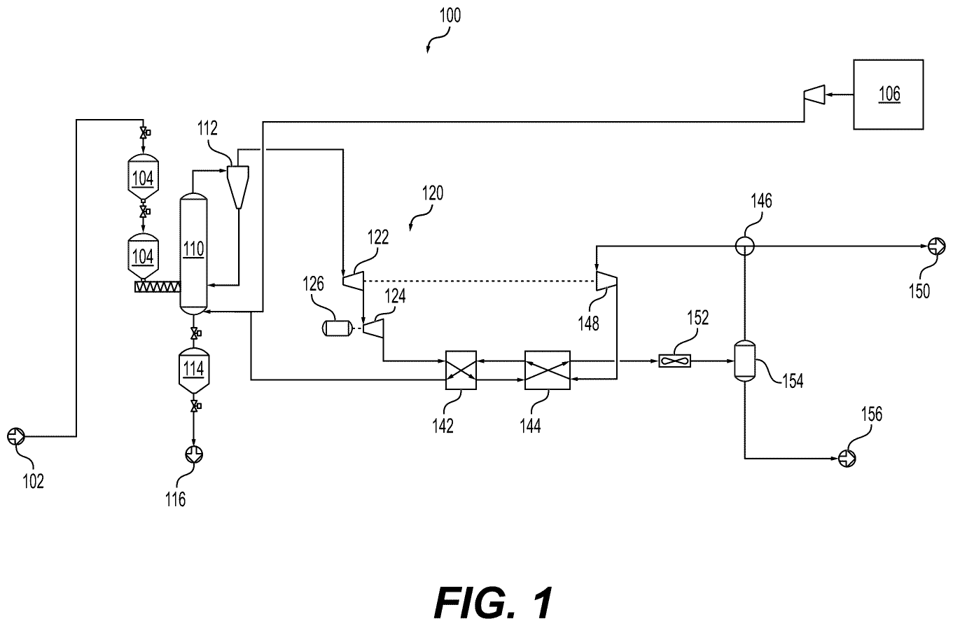

The embodiments of FIGS. 1, 2, and 3 depict high-pressure integrated gasification and power generation systems in which warm, high-pressure CO₂ is directed from the power generation portion of the system to the gasifier. In such systems, CO₂ working fluid may be compressed, pumped, and fed into one or more recuperators, where heat from the exit of one or more turbines may heat the CO₂ working fluid, and then the CO₂ working fluid may be directed from the recuperator and into the gasifier. The CO₂ working fluid may not need to be re-compressed before introduction to the gasifier, because it may be at a sufficiently high pressure already when exiting the recuperator(s). Detailed description of the exemplary embodiments is described below.

Referring to FIG. 1, the integrated gasification and power generation system 100 may include a biomass feed system, shown here as a plurality of feed hoppers 104, configured to introduce biomass into a high-pressure gasifier 110. The high-pressure gasifier 110 may be a slagging or a non-slagging gasifier. In some aspects, system 100 may include an ash hopper 114 operably connected to the high-pressure gasifier 110.

During operation, biomass feedstock 102 may be fed into the plurality of feed hoppers 104 (or other suitable feed system) to be pressurized for gasification. The biomass 102 may be comprised of any suitable carbonaceous product. For example, biomass 102 may be wood products (e.g., firewood, wood pellets, wood chips, lumber and sawdust waste, etc.), agricultural materials (e.g., corn, soybeans, sugar cane, woody plants, algae, etc.), biogenic materials in municipal solid waste (e.g., paper, cotton, wool products, food, yard waste, etc.), non-biogenic materials in municipal solid waste (e.g., plastics or petroleum-based products), animal manure, or human sewage (e.g., bio waste discharge from water treatment plants). While feed hoppers 104 are depicted in FIG. 1, any suitable feed system may be used in system 100. For example, a plug-forming screw feeder or a slurry pump may be used instead of feed hoppers 104. Any suitable feed system configured to pressurize the biomass 102 from an atmospheric pressure to a high operational pressure of the gasifier 110 may be used.

In the exemplary embodiment of FIG. 1, the high-pressure gasifier 110 may utilize an operational pressure ranging from about 100 bar to about 400 bar, e.g., from about 100 bar to about 350 bar, from about 100 bar to about 300 bar, from about 100 bar to about 250 bar, from about 100 bar to about 200 bar, from about 150 bar to about 400 bar, from about 150 bar to about 350 bar, from about 150 bar to about 300 bar, from about 150 bar to about 250 bar, from about 150 bar to about 200 bar, from about 200 bar to about 400 bar, from about 200 bar to about 350 bar, from about 200 bar to about 300 bar, or from about 200 bar to about 250 bar.

Within the gasifier 110, the CO₂ may act as a gasification medium for the biomass 102 as it enters the gasifier 110. Diatomic oxygen (O₂) (supplied and filtered via, e.g., an air separation unit 106), the pressurized biomass 102, and water vapor may be reacted to form a synthetic gas (“syngas,” which may comprise various amounts of diatomic hydrogen H₂, carbon monoxide CO, carbon dioxide CO₂, methane CH₄, water H₂O, and diatomic nitrogen N₂), with CO₂ forming a main working fluid. The CO₂ working fluid may be a supercritical CO₂ working fluid, subcritical CO₂ working fluid, or a combination thereof, and may be utilized to generate power and heat. In some aspects, supplemental partial oxidation may be used to condition the syngas. In some aspects, high pressures and a turbulent flow field in the reactor portion of the gasifier may lead to reduced gasification residence time allowing for a more compact gasifier.

As the biomass 102 gasifies within the gasifier 110, solids that cannot gasify may remain as solid waste byproducts 116 (e.g., fly ash, bottom ash, slag, etc.), which may settle to the bottom of the gasifier 110 and may be removed to the at least one ash hopper 114. Other solid particles may be entrained in the syngas. A particulate filter 112, e.g., a cyclone, water scrubber, or filter, which may be part of or separate from the gasifier 110, may be used to remove at least some of the solid particles from the syngas. For example, larger particles may be removed by one or more cyclones, and smaller particles that may otherwise cause erosion or fouling of downstream components may be removed by one or more scrubbers or filters (not shown). In some aspects, the syngas may be removed from the top of the gasifier 110 and may be funneled through a particulate filter 112, such as a cyclone filter or a ceramic candle filter, to remove at least some particulate matter. In some aspects, multiple different or multiple of the same type of particulate filter 112 may be used. The particulate filter 112, which may be integrated into the design of the gasifier 110 or as an external component, may be configured to remove solids or particulate matter in the syngas prior to the syngas entering the power generation loop 120.

If included, a water scrubber may be configured to clean the syngas by contacting the syngas with water to collect solids and salts that can cause damage to downstream equipment. When hot syngas contacts the water, some amount of the heat from the syngas may be lost due to heating and vaporization of the water into steam as it contacts the hot syngas. As a result, high-quality heat from the syngas may be turned into lower-quality heat as a result of the vaporization reaction and the resulting creation of steam, wasting energy. Scrubbers may operate at or below temperatures that generally match the saturation point for water at the pressure for which the scrubber is designed to operate. If incorporated into system 100 (or systems 200, 200′, 300, described below), the resulting scrubbed syngas may be substantially saturated with water at the outlet temperature, which may depend on the amount of heat the water absorbs to vaporize and equilibrate to the outlet condition. As a result, water scrubbers at ambient pressure may have a maximum syngas outlet at, e.g., approximately 100 degrees C., and may contain as much water as can be at that saturation point. By contrast, scrubbers in the disclosed embodiments may operate at elevated pressures, thus increasing the saturation temperature and allowing for less heat rejection, and subsequently more efficiency.

At approximately 200 bar, for example, a scrubber may operate up to a maximum temperature of approximately 366 degrees C. That may result in a large amount of water being present in the syngas, so the operating temperature may be significantly less to manage water partial pressure and facilitate combustion of the syngas. By incorporating a high-pressure gasifier, e.g., at approximately 100 to approximately 400 bar, a benefit is that if a scrubber is used, the water may have a higher saturation temperature, so syngas having a temperature warmer than the saturation temperature may still pick up some amount of steam, but the amount of steam generated may be less, and thus less energy may be wasted due to the vaporization of water. At lower pressures, that may result in low quality heat. A lot of heat may be lost from the high temperature syngas entering the scrubber to vaporization that isn't recovered. Cooling the syngas before scrubbing may thus inhibit the amount of water absorbed, and operating at high pressures may mean that heat from cooling the incoming syngas may be of higher quality and may be used for the thermodynamic cycle.

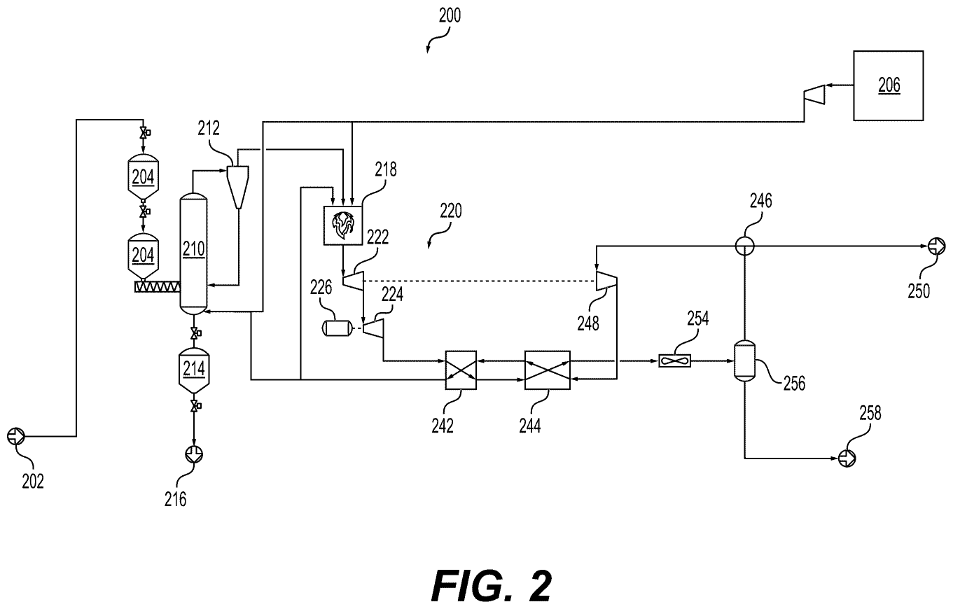

It should be noted that in exemplary FIG. 1, combustion and gasification occurs within the gasifier 110, and thus the syngas may be combusted to form a working fluid before exiting the gasifier 110. However, in other embodiments, such as FIGS. 2, 3, and 4, combustion may occur outside of the gasifier 110, and thus the working fluid may be formed external to the gasifier (e.g., in a combustor). More specifically, alternative embodiments may include a separate combustor 218, 318, which is supplied with the syngas produced by the gasifier (210 and 310 respectively), as well as atmospheric oxygen (supplied and filtered via, e.g., an air separation unit 206 and 306, respectively). Having a separate gasifier and combustor may allow for cleaning of the syngas prior to its introduction into the power generation loop.

Returning to FIG. 1, the filtered CO₂ working fluid leaving the gasifier may enter the power generation loop 120. The power generation loop 120 may be a recuperated Brayton thermodynamic cycle, which allows for the achievement of a higher temperature CO₂ working fluid. In the power generation loop 120, CO₂ working fluid may be expanded through a high-pressure turbine 122 (e.g., a turbine of a turbocompressor) and routed through a power generation turbine 124. The power generation turbine 124 may produce power sufficient for an electrical generator 126 to generate electrical energy, which may be directed to a power grid or converted to other forms of power (e.g., mechanical power). As shown in FIG. 1, hot CO₂ working fluid from the turbine exhaust may be flowed through one or more recuperators, e.g., a high-temperature recuperator 142 and a low-temperature recuperator 144. From low-temperature recuperator 144, the CO₂ working fluid may be passed through a heat exchanger 152, a water separator 154, and a high-pressure compressor 148, and then back through the low-temperature recuperator 144 and the high-temperature recuperator 142. CO₂ working fluid exiting the compressor 148 may be relatively cooler, and passing the CO₂ working fluid through the recuperators 144, 142 may increase the temperature of the CO₂ working fluid. From high-temperature recuperator 142, the CO₂ working fluid may be reintroduced into the gasifier 110, and additional oxygen may also be introduced into the gasifier 110. As discussed above, system 100 may not include a separate combustor, and combustion may occur within the gasifier 110.

System 100 may further include one or more sensors (not shown) that are configured to monitor pressure within the system. When a threshold pressure is reached or exceeded, some CO₂ may be vented from the system 100, e.g., via a gas vent 150. Water may be condensed from the CO₂ working fluid and removed, e.g., via a liquid vent 156. For example, in one aspect, the backpressure in the system may be controlled. In this aspect, the compressor 148 suction pressure may be monitored and controlled, and when the pressure detected meets or exceeds the threshold, control valve 146 in an exit line may open and may allow CO₂ to be released. In this manner, CO₂ may be pulled off from the low-pressure side of the power generation loop 120. As another option, the compressor 148 discharge pressure may be controlled, and when the pressure detected meets or exceeds the threshold, control valve 146 in an exit line may open and may allow CO₂ to be released from the high-pressure side of the loop.

CO₂ released from system 100 (or systems 200, 200′, 300 described below) may be sequestered. For example, the CO₂ released from system 100 may be transferred to a pipeline, e.g., for transport to an underground storage location. As one example, the CO₂ may be transported to a well, which may be a class VI well. In another example, the pipeline may transport the sequestered CO₂, e.g., to an entity that uses or otherwise consumes CO₂, such as a supplier of CO₂, a carbonated beverage company, etc. If the CO₂ is to be transferred to, e.g., an injection well at a high pressure, it may be beneficial to siphon off the CO₂ from the high-pressure side of the power generation loop 120, such as from the compressor 148 discharge.

FIG. 2 depicts another embodiment of a high-pressure integrated gasification and power generation system 200. System 200 may have similar components as system 100 and may function similarly to system 100, and at similar pressures (e.g., about 100 bar to about 400 bar) except as described further below. For example, in addition to having a gasifier 210, system 200 includes a separate combustor 218. Rather than burning biomass 202 and oxygen in one gasifier reactor vessel, only enough oxygen may be fed into the gasifier 210 (e.g., via an air separation unit 206) as is needed to accomplish gasification of the biomass 202 to form syngas. The generated syngas may be combusted in the separate combustor 218, with additional oxygen (supplied, e.g., by the air separation unit 206) to form and heat CO₂ working fluid. The power generation loop 220 may be a recuperated Brayton thermodynamic cycle, similar to FIG. 1, but the path of the CO₂ working fluid may split after leaving the recuperators so that some CO₂ is passed into the gasifier, while the rest is diverted to the combustor 218.

As with FIG. 1, the CO₂ working fluid may be a supercritical CO₂ working fluid, subcritical CO₂ working fluid, or a combination thereof, and may be utilized to generate power and heat. In some aspects, supplemental partial oxidation may be used to condition the syngas. In some aspects, high pressures and a turbulent flow field in the gasifier 218 may lead to reduced gasification residence time allowing for a more compact gasifier.

Similar to system 100, system 200 may include a suitable biomass feed system, such as a plurality of feed hoppers 204, or alternatively, for example, a plug-forming screw feeder or a slurry pump. As the biomass 202 gasifies within the gasifier 210, solids that cannot gasify may remain as solid waste byproducts 216 (e.g., fly ash, bottom ash, slag, etc.), which may settle to the bottom of the gasifier 210 and may be removed to the at least one ash hopper 214. Other solid particles may be entrained in the syngas. A particulate filter 212, e.g., a cyclone, water scrubber, or filter, which may be part of or separate from the gasifier 210, may be used to remove at least some of the solid particles from the syngas. For example, larger particles may be removed by one or more cyclones, and smaller particles that may otherwise cause erosion or fouling of downstream components may be removed by one or more scrubbers or filters (not shown). In some aspects, the syngas may be removed from the top of the gasifier 210 and may be funneled through a particulate filter 212, such as a cyclone filter or a ceramic candle filter, to remove at least some particulate matter. In some aspects, multiple different or multiple of the same type of particulate filter 212 may be used. The particulate filter 212, which may be integrated into the design of the gasifier 210 or as an external component, may be configured to remove solids or particulate matter in the syngas prior to the syngas entering the power generation loop 220.

As with system 100, the power generation loop 220 of system 200 may be a recuperated Brayton thermodynamic cycle. Filtered syngas may exit particulate filter 212 and flow into combustor 218, where it is combusted with oxygen, e.g., from air separation unit 206 to generate and heat CO₂ working fluid. Hot CO₂ working fluid may then be expanded through a high-pressure turbine 222 and routed through a power generation turbine 224. The power generation turbine 224 may produce power sufficient for an electrical generator 226 to generate electrical energy, which may be directed to a power grid or converted to other forms of power (e.g., mechanical power). The CO₂ working fluid may then be flowed through one or more recuperators, e.g., a high-temperature recuperator 242 and a low-temperature recuperator 244. From low-temperature recuperator 244, the CO₂ working fluid may be passed through a heat exchanger 254, a water separator 256, and a high-pressure compressor 248, and then back through the low-temperature recuperator 244 and the high-temperature recuperator 242. A benefit of the recuperated Brayton power generation loop may be that lower compression power may be needed in compressor 248, e.g., in the case of liquid-like supercritical CO₂ working fluid, so the working fluid may not get as hot as it exits the compressor 248. The working fluid may then be heated when passed through the recuperators 244, 242, which may capture heat from the turbine exhaust.

As described above, a portion of the CO₂ working fluid from the recuperators may be reintroduced into the gasifier 210, while a portion of the CO₂ working fluid may be reintroduced to the combustor 218. One benefit of this configuration is that relatively cold CO₂ working fluid may be heated via the recuperators 242, 244 before the CO₂ working fluid is combusted in combustor 218. In some aspects, the portion of CO₂ working fluid introduced into the combustor 218 and/or the gasifier 210 from the high-temperature recuperator 242 may be used for thermal conditioning. For example, when CO₂ working fluid is diverted to the gasifier 210, combustor 218 may essentially be used as a source of heat for heating the CO₂ working fluid to a higher temperature than the recuperators would be able to achieve on their own. This heated CO₂ working fluid circulated through the combustor 218 and introduced to the gasifier 210 may thus introduce additional heat into the gasifier 210. On the other hand, the CO₂ working fluid reintroduced into the combustor 218 from the recuperators may serve to cool the walls of the combustor 218 and to moderate the temperatures where combustion is taking place, since the heated CO₂ working fluid from the recuperators may be relatively cooler than the combustion temperatures in the combustor 218.

Similar to system 100, system 200 may also include one or more sensors (not shown) for monitoring pressure within the system. Pressure regulation and venting may occur as described in reference to system 100, with CO₂ being vented via a gas vent 250 by operation of, e.g., control valve 246. As with system 100, CO₂ from system 200 may be pulled from either the high-pressure or the low-pressure side of the power generation loop for carbon sequestration.

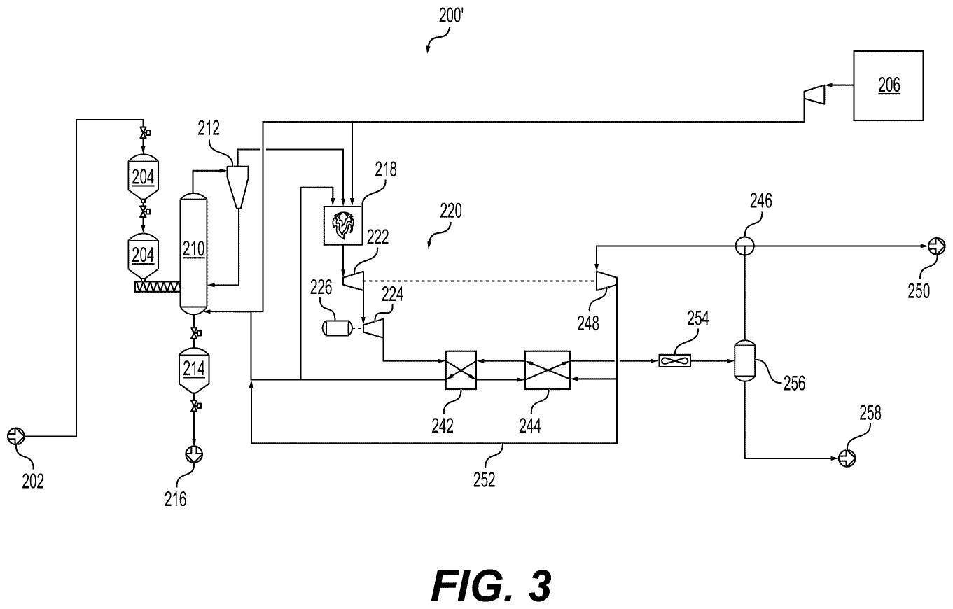

FIG. 3 depicts a system 200′ that is substantially the same as system 200 of FIG. 2, except that system 200′ may include bypass line 252 to help with the pinch point that may otherwise occur inside of the recuperator(s). In CO₂ cycles, e.g., supercritical CO₂ cycles, the recuperator pinch points may be limited based on the difference in heat capacity of the cold high-pressure CO₂ and the hot low pressure CO₂. To mitigate this problem, the mass flows through the recuperator may be changed. In this embodiment, relatively cold CO₂ from the compressor 248 may be pulled off upstream of the low-temperature recuperator 244 and diverted into bypass line 252 and to the gasifier 210, bypassing both recuperators 244, 242. By pulling some relatively colder CO₂ out of the recuperator, this CO₂ stream may be used to quench the syngas from the gasifier below the maximum scrubber temperature (which may inhibit vaporization losses), while matching the heat capacity of CO₂ streams in the recuperator. In some aspects, the bypass line 252 may direct the CO₂ from the compressor 248 to an upper portion of the gasifier 210.

In some aspects, some or all of the cold CO₂ in the bypass line 252 may additionally or alternatively be directed to the biomass feeder system (e.g., feed hoppers 204) to pressurize the feed hoppers, or cold CO₂ may be diverted to another component of the system for, e.g., pressurization of that component. In still other embodiments of the systems described herein, cold CO₂ may be diverted to a scrubber (if used). For example, cold CO₂ may be contacted with the CO₂ syngas exiting the gasifier 210. Heat from the gasifier syngas may be used to warm the diverted cold CO₂, causing the gasifier syngas to cool down. As a result of the cooler temperature, the syngas exiting the gasifier may generate less steam in the scrubber, thus wasting less of the syngas heat. Although not shown in reference to FIG. 1, a similar bypass line 252 leading to any suitable component or components may be incorporated into system 100 or system 300.

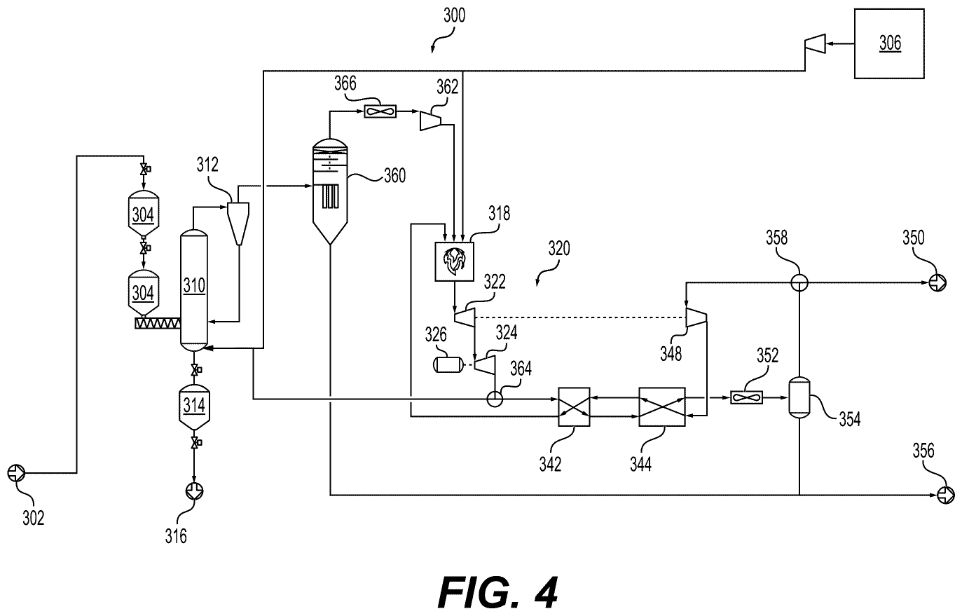

Although FIGS. 1-3 depict high-pressure integrated gasification and power generation systems, FIG. 4 depicts an alternative integrated gasification and power generation system configured to run the gasifier at relatively lower pressures compared to the embodiments of FIGS. 1-3. In the embodiment of FIG. 4, the gasifying agent (e.g., CO₂ working fluid), may be taken from the exit of the turbine 324, where it may be at a lower pressure after it has been expanded at a higher temperature. For example, the turbine exhaust may be at approximately 40 bar. This hot, lower pressure CO₂ working fluid may be diverted from the exhaust end of the turbine 324, e.g., at control valve 364, to the gasifier 310. In the gasifier 310, the CO₂ working fluid from the turbine exhaust may act as a gasification medium and may be mixed with oxygen and used to run the gasifier to gasify biomass. A benefit of this embodiment is that a traditional gasifier may be utilized, since traditional gasifiers may be configured to operate at lower pressures of, e.g., approximately 10 bar to approximately 40 bar, since the CO₂ working fluid from the turbine exhaust may enter the gasifier 310 at a similar pressure. The topping part of the cycle, however, may be approximately 180 bar, thus the gasifier syngas may need to be cooled, cleaned, and/or compressed, as described further below.

Similar to FIGS. 1-3, system 300 of FIG. 4 may include a suitable biomass feed system, such as a plurality of feed hoppers 304, or alternatively, for example, a plug-forming screw feeder or a slurry pump. As the biomass 302 gasifies within the gasifier 310, solids that cannot gasify may remain as solid waste byproducts 316 (e.g., fly ash, bottom ash, slag, etc.), which may settle to the bottom of the gasifier 310 and may be removed to the at least one ash hopper 314. Other solid particles may be entrained in the syngas. A particulate filter 312, e.g., a cyclone, scrubber, or filter, which may be part of or separate from the gasifier 310, may be used to remove at least some of the solid particles from the syngas. For example, larger particles may be removed by one or more cyclones, and smaller particles that may otherwise cause erosion or fouling of downstream components may be removed by one or more scrubbers or filters. The embodiment of FIG. 4 depicts a cyclone particulate filter 312 as well as a water scrubber 360. In some aspects, the syngas may be removed from the top of the gasifier 310 and may be funneled through the particulate filter 312, such as a cyclone filter or a ceramic candle filter and a scrubber 360, to remove at least some particulate matter. As described above, having a separate gasifier and combustor may allow for cleaning of the syngas prior to its entrance into the power generation loop.

After the exiting scrubber 360, the syngas stream may enter heat exchanger 366 and be heated up again (e.g., with the heat from cooling prior to the scrubber, as described above). From the heat exchanger 366, the syngas may be compressed via compressor 362, and then may be introduced into the combustor 318. The combustor 318 mixes the syngas from gasifier 310, oxygen (e.g., from air separator 306), and recirculated CO₂ working fluid from the recuperator 342, which may raise the temperature to the target turbine inlet temperature. Hot CO₂ working fluid from the combustor 318 may then be expanded through a high-pressure turbine 322 and routed through a power generation turbine 324. The power generation turbine 324 may produce power sufficient for an electrical generator 326 to generate electrical energy, which may be directed to a power grid or converted to other forms of power (e.g., mechanical power). In some aspects, the turbine 324 may generate power for the compressor and may drive electrical generator 326.

From turbine 324, some CO₂ working fluid may be directed to the gasifier 310, and some CO₂ working fluid may be flowed through one or more recuperators, e.g., a high-temperature recuperator 342 and a low-temperature recuperator 344. From low-temperature recuperator 344, the CO₂ working fluid may be passed through a heat exchanger 352, a water separator 354, and a high-pressure compressor 348, and then back through the low-temperature recuperator 344 and the high-temperature recuperator 342. The CO₂ working fluid may then be heated when passed through the recuperators 344, 342, which may capture the heat from the turbine exhaust. CO₂ working fluid from the recuperator 342 may be reintroduced into the combustor 318. One benefit of this configuration is that cold CO₂ working fluid may be heated via the recuperators 342, 344 before the CO₂ working fluid is heated by gasifier syngas combustion in combustor 318. In some aspects, the CO₂ working fluid introduced into the combustor 318 from the high-temperature recuperator 342 may serve to cool the walls of the combustor 318 and to moderate the temperatures where combustion is taking place, since the heated CO₂ working fluid may still be cooler than the combustion temperatures in the combustor 318. As described above, in the embodiment of FIG. 4, CO₂ working fluid may be diverted from the low-pressure side of the cycle, which may allow the gasifier to operate at a lower pressure. Because of the use of a lower pressure gasifier 310 (e.g., operating at about 35-40 bar), heat exchanger 366 and compressor 362 may be incorporated to cool and compress the CO₂ syngas prior to introduction to the combustor 318. Compared to systems 100, 200, 200′, system 300 may be relatively less efficient, although still viable, due to wasted heat from cooling and condensing water from the syngas stream prior to compression and introduction into combustor 318.

Similar to systems 100, 200, 200′, system 300 may also include one or more sensors (not shown) for monitoring pressure within the system. Pressure regulation and venting may occur as described in reference to system 100, with CO₂ being vented via a gas vent 350, e.g., by operation of control valve 358. As with system 100, CO₂ from system 300 may be pulled from either the high-pressure or the low-pressure side of the loop for carbon sequestration.

Although the systems of FIGS. 1-4 depict power generation loops in the form of recuperated Brayton cycles, some embodiments of the disclosure may alternatively be drawn to systems incorporating Brayton cycles. In a traditional Brayton (i.e., not recuperated Brayton) cycle, exhaust CO₂ working fluid from a turbine may be recirculated. An air breathing gas turbine may be used, and flu gas may be recirculated. A portion of the compressor discharge may be redirected into the gasifier, e.g., approximately 20% of the compressor discharge may be directed into the gasifier. In some aspects, the pressure requirement for the combustor may be approximately equal to the compressor discharge. In operation, the Brayton-based system may recirculate exhaust gas.

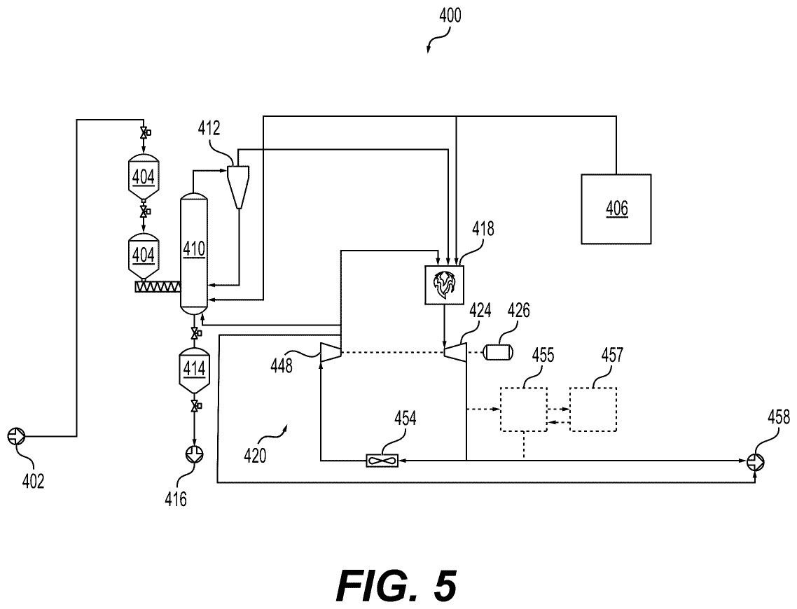

FIG. 5 depicts an example of an integrated gasification and power generation system 400 that incorporates a Brayton cycle, as opposed to a recuperated Brayton cycle. System 400 may have some similar components as system 200 and may function similarly to system 200, except as described further below. For example, system 400, unlike system 200 and those described above, does not include one or more recuperators. In some aspects, the closed-loop Brayton cycle of FIG. 5 may operate at a pressure of approximately 25 bar, or less than approximately 25 bar.

The power generation loop 420 may be a closed-loop Brayton thermodynamic cycle. The path of the CO₂ working fluid through the power generation loop 420 may extend from the combustor 418, to a turbine 424, then through a heat exchanger 454. Heat from the CO₂ working fluid may be removed by the heat exchanger 454, and then the CO₂ working fluid may be passed to a compressor 448. After exiting the compressor 448, the path of the CO₂ working fluid may split so that a portion of the compressed CO₂ is passed into the gasifier 410 and/or is diverted to the combustor 418, rather than to a recuperator. As also shown in FIG. 5, system 400 may be configured to pass at least some of the compressed CO₂ to a gas vent 458.

The CO₂ working fluid may be a subcritical CO₂ working fluid, supercritical CO₂ working fluid, or a combination thereof, and may be utilized to generate power and heat. Although a CO₂ working fluid is discussed in reference to FIG. 5, it is recognized that the CO₂ working fluid in the closed-loop embodiment of FIG. 5 may have a relatively greater percentage of water in it as compared to embodiments discussed in reference to FIGS. 1-4. For example, at a lower pressure, approximately 14% of the CO₂ working fluid may be water as the working fluid enters the compressor 448. In some aspects, supplemental partial oxidation may be used to condition the syngas.

Similar to the systems of FIGS. 1-4, system 400 may include a suitable biomass feed system, such as a plurality of feed hoppers 404, or alternatively, for example, a plug-forming screw feeder or a slurry pump. As the biomass 402 gasifies within the gasifier 410, solids that cannot gasify may remain as solid waste byproducts 416 (e.g., fly ash, bottom ash, slag, etc.), which may settle to the bottom of the gasifier 410 and may be removed to the at least one ash hopper 414. Other solid particles may be entrained in the syngas. A particulate filter 412, e.g., a cyclone, water scrubber, or filter, which may be part of or separate from the gasifier 410, may be used to remove at least some of the solid particles from the syngas. For example, larger particles may be removed by one or more cyclones, and smaller particles that may otherwise cause erosion or fouling of downstream components may be removed by one or more scrubbers or filters (not shown). In some aspects, the syngas may be removed from the top of the gasifier 410 and may be funneled through a particulate filter 412, such as a cyclone filter or a ceramic candle filter, to remove at least some particulate matter. In some aspects, multiple particulate filters 412 may be used, such as multiple particulate filters 412 of the same type and/or multiple particulate filters 412 of different types. The particulate filter 412, which may be integrated into the design of the gasifier 410 or as an external component, may be configured to remove solids or particulate matter in the syngas prior to the syngas entering the power generation loop 420.

Filtered syngas may exit particulate filter 412 and flow into combustor 418, where it is combusted with oxygen, e.g., from air separation unit 406 to generate a heated CO₂ working fluid. Hot CO₂ working fluid may then be expanded through a power generation turbine 424 downstream of combustor 418. The power generation turbine 424 may produce power sufficient for an electrical generator 426 to generate electrical energy, which may be directed to a power grid or converted to other forms of power (e.g., mechanical power). In one optional configuration of system 400, system 400 may be a combined cycle power plant, and the CO₂ working fluid may be passed from the turbine 424 to a heat recovery steam generator 455 and to a steam turbine and generator 457. This may allow for the extraction of more power from system 400 and may increase the efficiency of system 400. Because Brayton cycles tend to operate at higher temperatures compared to recuperated Brayton cycles, the extra heat from the combined system 400 may be used to boil water to power the steam turbine and generator 457, which may allow a combined version of system 400 to extract additional power from the system. Whereas the recuperated Brayton cycle may capture heat exiting the turbine and use it to heat the working fluid via the inclusion of recuperators in order to achieve system efficiencies, the combined Brayton cycle of system 400 may gain efficiencies by using the excess heat to generate additional power from the steam turbine and generator 457.

The CO₂ working fluid may be passed from the turbine 424 to the heat exchanger 454 and into the compressor 448. The CO₂ working fluid passed through the compressor 448 may experience a relatively higher increase in temperature compared to the recuperated Brayton systems described above. As described above, a portion of the CO₂ working fluid from the compressor 448 may be reintroduced into the gasifier 410, while a portion of the CO₂ working fluid may be reintroduced to the combustor 418. The portion of CO₂ working fluid that is passed to vent 458 may first pass through a compression and purification unit (e.g., component(s) for drying and removing impurities from the CO₂, and if desired, for further compressing the CO₂). This may result in provision of a more pure CO₂ gas to a well, truck, or other location for capturing the CO₂.

In some aspects, system 400 may be configured for operating at a relatively large pressure ratio, the pressure ratio being the ratio of a top, or highest, pressure achieved within the system to a bottom, or a lowest pressure achieved within the system. In some aspects, the top pressure corresponds to the pressure at the outlet of compressor 448 and/or the pressure at the inlet of combustor 418. The bottom pressure may correspond to the pressure at the inlet of compressor 448.

The pressure ratio between the top pressure and the bottom pressure may be, for example, approximately 20:1 to approximately 25:1, or up to approximately 70:1. The bottom pressure may be selected to reduce the top pressure, as well as the overall pressure, for the closed-loop Brayton cycle. For example, the bottom pressure may correspond to ambient pressure, or may correspond to vacuum pressure. In one aspect, the bottom pressure may be selected such that the top pressure may correspond to a pressure below the critical point of the working fluid. In other examples, the bottom pressure may be selected such that the top pressure is above the critical point, resulting in formation of a supercritical fluid. In configurations in which vacuum pressure is used to achieve the bottom pressure, the bottom pressure may be approximately 0.10 bar or approximately 0.01 bar. In configurations in which pressure other than vacuum is used to achieve the bottom pressure, the bottom pressure may be approximately 10 bar, approximately 15 bar, approximately 20 bar, approximately 25 bar, approximately 30 bar, or approximately 35 bar.

In some aspects, the size of compressor 448 may affect what pressure ranges are achieved within the system. In systems 400 with lower bottom pressures, for example, a larger compressor 424 may be sized larger to achieve the desire pressure ratio used. In configurations with greater pressure ratios, power generation loop 420 may be configured to operate with higher temperatures.

As with the previously discussed systems, system 400 may also include one or more sensors (not shown) for monitoring pressure within the system, and pressure regulation and venting may occur in system 400.

In the embodiments described above, the systems may be started up in one or more ways. In one aspect, combustion in the power generation loop may be initiated with a reserve of fuel, e.g., syngas, methane, propane, or any other suitable combustible fuel. Then, once a sufficient amount of hot CO₂ working fluid has been produced, the gasifier may be started up in a manner similar to how the gasifier is operated during normal operation of the system, as described above. For example, in some aspects, a reserve of syngas may be stored in a buffer tank for the purpose of starting up the power generation loop, and when a sufficient amount of hot CO₂ working fluid is produced, it may be diverted to the gasifier to be used as a gasification medium. Oxygen may already be present in the gasifier or may be introduced into the gasifier as well. Even if the CO₂ working fluid is only warm because the recuperators have not reached normal operating temperatures, oxygen may be introduced to increase the gasifier temperatures.

In some aspects, to start the systems, a heater within the system or external to the system may be used to heat the CO₂ working fluid, and low temperature CO₂ reserves may be pumped up and put into the gasifier. On the way to the gasifier, at least a portion of the CO₂ may be heated up using a startup heater, or using a startup combustor (and, e.g., a fuel and heat), to initiate the power generation loop and overall system.

In another aspect, the gasifier may be started first by injecting more oxygen in a more traditional oxygen-blown manner. A cold CO₂ stream and oxygen may be combusted in the gasifier to produce hot syngas, which may then be introduced into the power generation loop.

Any suitable gasifier may be incorporated into one or more of the systems described herein. In embodiments in which a gasifier is designed for high-pressure use (e.g., from approximately 100 bar to approximately 400 bar), gasifiers must be robust enough to withstand such operation pressures. For example, the thickness or type of metal of which the gasifier is made should be appropriate for such conditions. In some aspects, the gasifier may be formed of a metal that is resistant to the corrosive properties of CO₂, if CO₂ is the intended gasification media. Such metals include, for example, Inconel metals, stainless steel, etc.

In some aspects, the gasifier may include pathways within and/or around the walls of the gasifier in order to permit the flow of a fluid through and/or around the walls of the gasifier to thermally condition the gasifier. For example, CO₂ may be run through or around the walls of the gasifier to cool them during operation before entering into the reaction zone. Even hot CO₂ from the recuperator(s) may be relatively cooler compared to the temperature of the reactions occurring within the gasifier during operation. Warm or hot CO₂ may be desirable for this purpose to avoid thermally shocking the metal of the gasifier. In other aspects, e.g., when starting up the gasifier, warm or hot CO₂ may be run through or around the walls of the gasifier in order to pre-heat the gasifier. Pre-heating the gasifier may inhibit the buildup of tar on the walls of the gasifier, which may occur if the walls are cold. In some aspects, if oxygen is used to thermally maintain temperatures, then there may be areas of the gasifier that are hotter than the CO₂ inlet temperature, and so hot CO₂ may now be cooler than in the reaction zone of the gasifier, and it may be possible to keep the metal in those areas cooler.

Further, different types of gasifiers may be used in the integrated gasification and power generation systems described herein. For example, slagging or non-slagging gasifiers may be used in the systems described herein. Slagging gasifiers may heat the biomass to a temperature hot enough that ash is melted then condensed to form slag. For example, in a slagging gasifier, the reaction zone may reach high temperatures, e.g., of about 1600 degrees Fahrenheit. The slag may then be cooled so that it exits the bottom of the gasifier as a liquid or solid. To cool the slag, water may be sprayed, and the water may provide nucleation sites for the slag to solidify and cool. Heating to high temperature followed by immediate cooling, however, may waste energy, decreasing efficiency.

If, however, a slagging gasifier is used in the high-pressure embodiments described herein, then it may be possible to achieve higher temperatures in certain zones of the slagging gasifier to fully gasify the biomass. Then, instead of water, some CO₂ from the power generation loop may be reintroduced into the gasifier, as described above, and may be used to cool internal gasifier fluid below the ash fusion temperature, condensing the slag. It may also be possible to slag and use CO₂ to quench syngas flow instead of using and wasting water and heat (i.e., through vaporization of the water, as described above). As a result, using the systems described herein may improve the efficiency of slagging gasifier operation, although the systems could also support non-slagging modes of operation.

Other benefits of one or more of the systems described herein may be as described further below. In some aspects, less biomass fuel may need to be burned to generate the syngas, because hot CO₂ from the power generation loop may be introduced into the gasifier to aid with heating. This may result in a higher gasifier cold gas efficiency.

Conventional gasifiers use air, oxygen, and/or steam for gasification and generate that heat from combustion directly with the carbonaceous fuel or externally for steam. By contrast, one or more systems described herein may shift the hottest combustion and use of oxygen to a separate combustor, so that the hottest and best heat may be achieved where it is most productive to extract energy from. Lower level heat from other portions of the system may instead be introduced into the gasifier (e.g., the reintroduction of CO₂ working fluid, as described above) to run the gasifier. This design may allow for greater efficiency, as the hottest heat source in the system may be used for energy generation, and cooler heat sources may instead be used for powering the gasifier. In this case, heat and gasifying medium are supplied from the integrated thermodynamic power generation cycle and are inherent to it. Comparatively less heat may be wasted, and gasification may be improved over conventional methods by higher carbon conversion, higher cold gas efficiency, and reduced tar formation.

In most thermodynamic power generation cycles, creating high-pressure, hot CO₂ as the gasification medium would be very difficult due to the high temperatures and pressures required and constraints of standard gasifiers, and thus such systems have not been pursued. For the integrated concepts described herein, however, the hot, pressurized CO₂ is inherent to the power cycle and provides a non-obvious benefit to a supercritical CO₂ power cycle for use with biomass. Since the gasifier (and scrubber, if included) operate at elevated pressures, raw wet biomass may be used, e.g., to inhibit energy being consumed in the drying of biomass, since the heating of that water in the biomass isn't as detrimental. In fact, using wet biomass can be beneficial in the gasification step where conventionally water may be added to support the water shift reaction to control H₂/CO ratios in the syngas. Wet biomass would normally be avoided due to its resulting impact to cold gas efficiency, but in this application, the heat that would normally be lost (resulting in lowing cold gas efficiency) is retained, and the presence of water may help by providing more H₂ for downstream combustion improvements.

While some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

We claim:

1. An integrated gasification and power generation system, comprising:
a gasifier configured to receive biomass and generate syngas, wherein the gasifier is configured to operate at a pressure of approximately 100 bar to approximately 400 bar; and
a recuperated Brayton thermodynamic power generation loop configured to receive the generated syngas and convert the generated syngas into a CO₂ working fluid, wherein at least a portion of the CO₂ working fluid from the power generation loop is reintroduced from the power generation loop to the gasifier.

2. The system of claim 1, wherein the generated syngas passes from the gasifier to a combustor, wherein the syngas is converted to the CO₂ working fluid within the combustor.

3. The system of claim 2, wherein the CO₂ working fluid passes from the combustor, to one or more turbines, through a plurality of recuperators, and then back through the plurality of recuperators, and wherein at least a portion of the CO₂ working fluid is passed from the plurality of recuperators and back to the gasifier.

4. The system of claim 3, wherein at least a portion of the CO₂ working fluid is passed from the plurality of recuperators back to the combustor.

5. The system of claim 3, wherein the CO₂ working fluid is passed from the plurality of recuperators to a heat exchanger, a water separator, and a compressor, prior to passing back through the plurality of recuperators.

6. The system of claim 3, wherein the plurality of recuperators comprises a low-temperature recuperator and a high-temperature recuperator.

7. The system of claim 3, further comprising a bypass line configured to divert a portion of the CO₂ working fluid after the CO₂ working fluid exits the plurality of recuperators and before the CO₂ working fluid passes back through the plurality of recuperators.

8. The system of claim 7, wherein the bypass line is configured to divert the portion of the CO₂ working fluid to one or more of the gasifier, a biomass feeder system configured to introduce the biomass into the gasifier, or a scrubber configured to clean the generated syngas exiting the gasifier.

9. The system of claim 1, further comprising a plurality of pressure sensors, wherein when pressure within the system is detected by at least one of the plurality of pressure sensors as being above a threshold pressure, the system is configured to vent a portion of CO₂ from the system.

10. The system of claim 9, wherein the CO₂ vented from the system is sequestered.

11. An integrated gasification and power generation system, comprising:
a gasifier configured to receive biomass and generate syngas, and to combust the syngas into a CO₂ working fluid, wherein the gasifier is configured to operate at a pressure of approximately 100 bar to approximately 400 bar; and
a recuperated Brayton thermodynamic power generation loop configured to receive the CO₂ working fluid, wherein at least a portion of the CO₂ working fluid is reintroduced from the power generation loop to the gasifier.

12. The system of claim 11, wherein the biomass is fully converted to the CO₂ working fluid within the gasifier.

13. The system of claim 11, wherein the CO₂ working fluid passes from the gasifier, to one or more turbines, through a plurality of recuperators, and then back through the plurality of recuperators, and wherein at least a portion of the CO₂ working fluid is passed from the plurality of recuperators and back to the gasifier.

14. The system of claim 13, wherein the CO₂ working fluid is passed from the plurality of recuperators to a heat exchanger, a water separator, and a compressor, prior to passing back through the plurality of recuperators.

15. The system of claim 13, wherein the plurality of recuperators comprises a low-temperature recuperator and a high-temperature recuperator.

16. The system of claim 13, further comprising a bypass line configured to divert a portion of the CO₂ working fluid after the CO₂ working fluid exits the plurality of recuperators and before the CO₂ working fluid passes back through the plurality of recuperators.

17. The system of claim 16, wherein the bypass line is configured to divert the portion of the CO₂ working fluid to one or more of the gasifier, a biomass feeder system configured to introduce the biomass into the gasifier, or a scrubber configured to clean the generated syngas exiting the gasifier.

18. A method of operating an integrated gasification and power generation system, the method comprising:
receiving biomass within a gasifier;
using the biomass and oxygen, generating syngas within the gasifier, wherein the gasifier is operated at a pressure of approximately 100 bar to approximately 400 bar;
combusting the syngas to form and heat a CO₂ working fluid;
passing the CO₂ working fluid through a turbine;
passing the CO₂ working fluid through a recuperator;
passing the CO₂ working fluid through a compressor;
passing at least a portion of the CO₂ working fluid back through the recuperator; and
passing at least a portion of the CO₂ working fluid back into the gasifier.

19. The method of claim 18, wherein generating the syngas within the gasifier further includes using the at least a portion of the CO₂ working fluid passed back into the gasifier.

20. The method of claim 18, wherein the recuperator includes a high-temperature recuperator and a low-temperature recuperator.

21. The method of claim 18, wherein the turbine includes a plurality of turbines.

22. The method of claim 18, further comprising cleaning the syngas prior to combusting the syngas.

23. The method of claim 18, wherein combusting the syngas occurs within the gasifier.

24. The method of claim 18, wherein combusting the syngas occurs within a combustor, separate from the gasifier.

25. The method of claim 24, further comprising passing at least a portion of the CO₂ working fluid back into the combustor.

26. The method of claim 18, further comprising diverting at least a portion of the CO₂ working fluid into a bypass line prior to passing the at least a portion of CO₂ working fluid back through the recuperator.

27. The method of claim 26, wherein the portion of the CO₂ working fluid diverted into the bypass line is directed to at least one of the gasifier, a biomass feeder system configured to introduce the biomass into the gasifier, or a scrubber configured to clean the generated syngas.

28. The method of claim 18, further comprising monitoring a pressure within the system, and wherein, when the pressure within the system exceeds a threshold pressure, a portion of the CO₂ working fluid is vented from the system.

29. The method of claim 28, further comprising sequestering the CO₂ vented from the system.
